(19) United States
(12) Patent Application Publication
(10) Pub. No.: US 2024/0094675 A1
(43) Pub. Date: Mar. 21, 2024

(54) METHOD FOR INSPECTING AUTHENTICITY OF A HOLOGRAM

(71) Applicant: National Chung Cheng University, Minsyong Township (TW)

(72) Inventors: Hsiang-Chen Wang, Minsyong Township (TW); Yu-Ming Tsao, Minsyong Township (TW); Arvind Mukundan, Minsyong Township (TW)

(21) Appl. No.: 18/176,610

(22) Filed: Mar. 1, 2023

(30) Foreign Application Priority Data
Sep. 16, 2022 (TW) 111135196

(51) Int. Cl. G03H 1/00

(52) U.S. Cl. CPC G03H 1/0011

(57) ABSTRACT

A method for inspecting authenticity of a hologram is provided. A computer device that stores a color image of the hologram transforms the color image into a hyperspectral image, converts the hyperspectral image into a grayscale image, and determines authenticity of the hologram based on multiple grayscale values in a region of interest in the grayscale image and multiple grayscale thresholds that respectively correspond to different wavelengths.

### CROSS-REFERENCE TO RELATED APPLICATION

This application claims priority to Taiwanese Invention Patent Application No. 111135196, filed on Sep. 16, 2022.

### FIELD

The disclosure relates to an authenticating method, and more particularly to a method for inspecting authenticity of a hologram.

### BACKGROUND

Recently, holograms that are developed based on laser holography are used for anti-counterfeiting purposes. Holography is a photography technique that records all information (e.g., amplitudes, phases, etc.) of light waves reflected by or transmitted through a subject, so the light waves can be reconstructed using a medium, such as a film, and the reconstructed hologram of the subject would produce three-dimensional vision for an observer and look so real that the observer can see different aspects of the subject by viewing the hologram from different angles or orienting the hologram differently.

### SUMMARY

An object of the disclosure is to provide a method for inspecting authenticity of a hologram.

According to the disclosure, the method includes steps of: by a computer device that stores a color image of the hologram, transforming the color image into a hyperspectral image; by the computer device, converting the hyperspectral image into a grayscale image; and by the computer device, determining authenticity of the hologram based on multiple grayscale values in a region of interest in the grayscale image and multiple grayscale thresholds that respectively correspond to different wavelengths.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a computer device that implements an embodiment of a method for inspecting authenticity of a hologram according to the disclosure.

FIG. 2 is a flow chart illustrating steps of the embodiment.

FIG. 3 is a flow chart illustrating sub-steps of step 24 in FIG. 2.

FIG. 4 is a plot illustrating a comparison between an original hologram and a counterfeit hologram.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

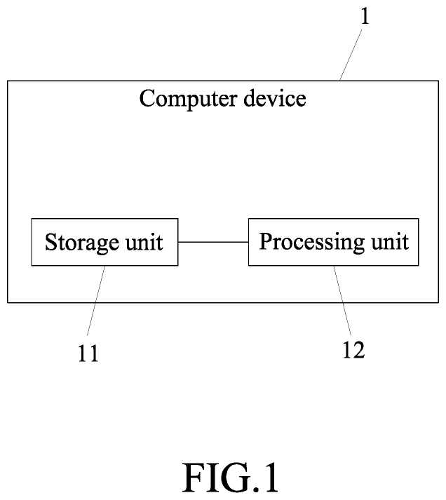

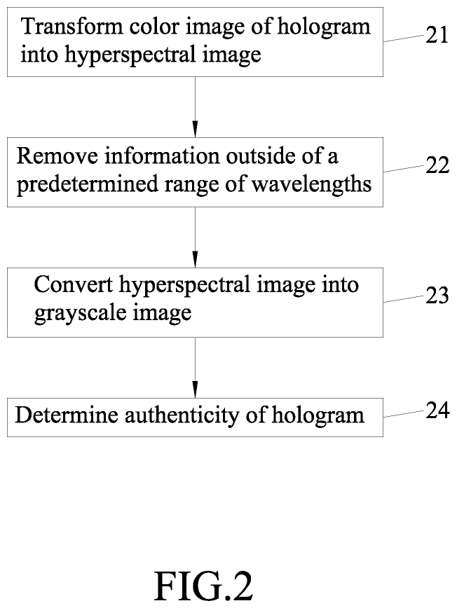

Referring to FIGS. 1 and 2, an embodiment of a method for inspecting authenticity of a hologram according to this disclosure is to be implemented by a computer device 1. The computer device 1 includes a storage unit 11 and a processing unit 12 that are electrically connected to each other. The storage unit 11 may be realized using a volatile or non-volatile storage medium, such as random access memory, a hard disk drive, a solid state drive, flash memory, etc. The processing unit 12 may be realized as, for example, a processor, a microcontroller, or any integrated circuit that has computational capability. The storage unit 11 stores a color image of the hologram, which may be a two-dimensional image captured by a camera (not shown), but this disclosure is not limited in this respect. The color image has a region of interest (ROI) that is related to the hologram (e.g., a predetermined part of the hologram). The embodiment includes steps 21-24.

In step 21, the processing unit 12 uses a hyperspectral imaging algorithm to transform the color image into a hyperspectral image that includes information with respect to a plurality of wavelengths (e.g., spectral information). For the hyperspectral imaging algorithm, reference may be made to, for example, Taiwanese Patent No. 1732544, so details thereof are omitted herein for the sake of brevity, but this disclosure is not limited in this respect.

In step 22, the processing unit 12 filters out (namely, removes) a part of the information of the hyperspectral image that corresponds to those of the wavelengths falling outside of a predetermined range of wavelengths to obtain a narrow-band hyperspectral image. Accordingly, the narrow-band hyperspectral image includes only a remaining part of the information of the hyperspectral image that corresponds to those of the wavelengths falling within the predetermined range of wavelengths.

In step 23, the processing unit 12 converts the narrow-band hyperspectral image into a narrow-band grayscale image. The narrow-band grayscale image includes a plurality of grayscale values that correspond to multiple pixels thereof. Since the narrow-band grayscale image is converted from the color image, the narrow-band grayscale image has the same region of interest as the color image.

In step 24, the processing unit 12 determines authenticity of the hologram based on those of the grayscale values that are in the region of interest in the grayscale image and multiple predetermined grayscale thresholds that respectively correspond to different wavelengths.

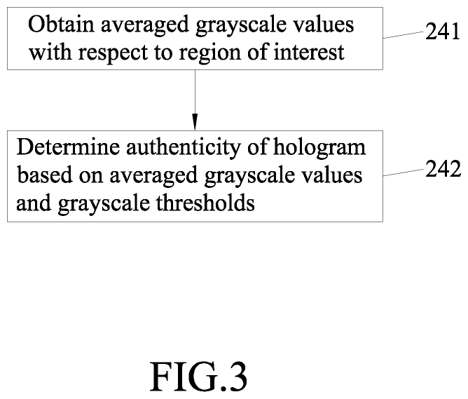

Further referring to FIG. 3, step 24 includes sub-steps 241 and 242.

In sub-step 241, for each of the different wavelengths the predetermined grayscale thresholds correspond, the processing unit 12 averages those of the grayscale values in the region of interest that correspond to the wavelength, so as to obtain an averaged grayscale value that corresponds to the wavelength. As a result, the processing unit 12 obtains a plurality of averaged grayscale values that respectively correspond to the different wavelengths.

In sub-step 242, the processing unit 12 determines authenticity of the hologram based on the predetermined grayscale thresholds and the averaged grayscale values.

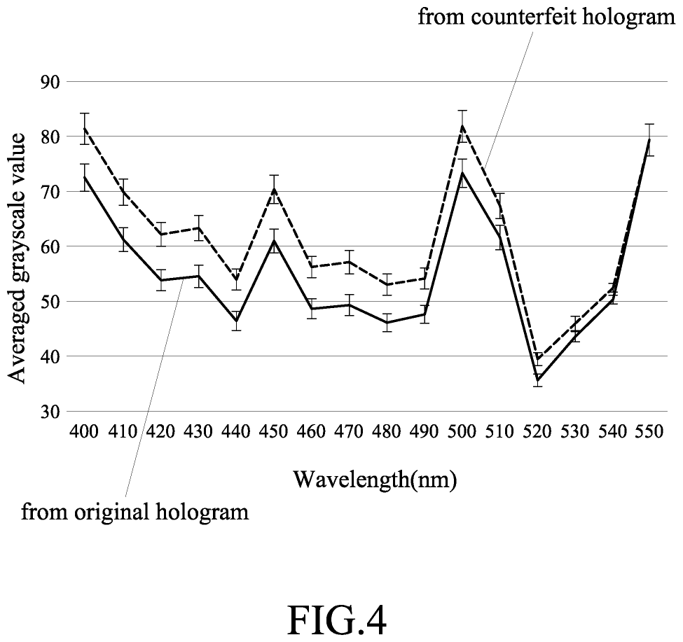

FIG. 4 exemplarily illustrates a solid line that is formed by averaged grayscale values obtained using the embodiment of the method from an original hologram, and a dotted line that is formed by averaged grayscale values obtained using the embodiment of the method from a counterfeit hologram. In this example, most of the averaged values obtained from the counterfeit hologram are greater than the corresponding averaged values obtained from the original hologram (i.e., corresponding in terms of wavelength), and the predetermined grayscale thresholds can be decided based on the averaged grayscale values obtained from the original hologram. The processing unit 12 may be configured to determine that a to-be-inspected hologram is a counterfeit (not authenticated) upon determining that any one of averaged grayscale values obtained from the to-be-inspected hologram is greater than the corresponding one of the predetermined grayscale thresholds (i.e., corresponding in terms of wavelength), and to authenticate the to-be-inspected hologram when each of the averaged grayscale values obtained from a to-be-inspected hologram is not greater than the corresponding one of the predetermined grayscale thresholds. In some embodiments, the original hologram may be made such that the averaged grayscale values obtained from a counterfeit hologram will generally be smaller than those obtained from the original hologram. In such a case, the processing unit 12 may be configured to determine that a to-be-inspected hologram is a counterfeit when any one of averaged grayscale values obtained from the to-be-inspected hologram is smaller than a corresponding one of the predetermined grayscale thresholds that are decided based on the averaged grayscale values obtained from the original hologram, and to authenticate the to-be-inspected hologram when each of the averaged grayscale values obtained from the to-be-inspected hologram is not smaller than the corresponding one of the predetermined grayscale thresholds.

Furthermore, in step 22, the range of wavelengths for the narrow-band operation may be determined to correspond to a wavelength segment in which the counterfeit hologram has a significant difference from the original hologram in terms of the average grayscale values, such as a range from 500 nm to 510 nm in FIG. 4. The narrow-band operation may reduce computational load of the processing unit 12, and reduce a probability of misjudging authenticity of the hologram. If the original hologram is made such that any counterfeit hologram will have great differences from the original hologram at all, or almost all, wavelengths, step 22 may be omitted.

In summary, the embodiment of the method for inspecting authenticity of a hologram according to this disclosure uses the processing unit 12 to transform the color image of the hologram into the hyperspectral image that has plentiful spectral information, and to convert the hyperspectral image into a grayscale image or a narrow-band grayscale image, so the processing unit 12 can use the grayscale values in the region of interest in the grayscale image or the narrow-band grayscale image to determine authenticity of the hologram based on the predetermined grayscale thresholds.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that to this disclosure is not limited to the disclosed embodiment(s) but is intended to cover various arrangements included within the spirit and scope of the broadest interpretation so as to encompass all such modifications and equivalent arrangements.

What is claimed is:

1. A method for inspecting authenticity of a hologram, comprising steps of:
by a computer device that stores a color image of the hologram, transforming the color image into a hyperspectral image;
by the computer device, converting the hyperspectral image into a grayscale image; and
by the computer device, determining authenticity of the hologram based on multiple grayscale values in a region of interest in the grayscale image and multiple grayscale thresholds that respectively correspond to different wavelengths.

2. The method as claimed in claim 1, further comprising, between the step of transforming and the step of converting, a step of, by the computer device, removing a part of information of the hyperspectral image that corresponds to wavelengths falling outside of a predetermined range of wavelengths.

3. The method as claimed in claim 1, wherein the step of determining authenticity includes:
averaging, for each of the different wavelengths, those of the grayscale values in the region of interest that correspond to the wavelength to obtain an averaged grayscale value that corresponds to the wavelength; and
determining authenticity of the hologram based on the grayscale thresholds and the averaged grayscale values that correspond to the different wavelengths.
